(19) United States
(12) Patent Application Publication
(10) Pub. No.: US 2022/0005017 A1
(43) Pub. Date: Jan. 6, 2022

(54) ELECTRONIC DEVICE AND SYSTEM FOR PAYMENT IN VEHICLE

(71) Applicants: Hwa Jin LEE, Seoul (KR); ParkingCloud Co., Ltd., Seoul (KR)

(72) Inventors: Hwa Jin LEE, Seoul (KR); Sang Yong SHIN, Seoul (KR)

(73) Assignee: ParkingCloud Co., Ltd., Seoul (KR)

(21) Appl. No.: 17/295,147

(22) PCT Filed: Oct. 23, 2019
(86) PCT No.: PCT/KR2019/013964

§ 371 Date: May 19, 2021

(30) Foreign Application Priority Data
Nov. 21, 2018 (KR) 10-2018-0144889

(51) Int. Cl. G06Q 20/32; G07B 15/04; B60K 35/00; H04W 4/44; G06K 9/00

(52) U.S. Cl. CPC G06Q 20/327; G06Q 20/325; G07B 15/04; B60K 35/00; G06K 2209/15; G06K 9/00664; B60K 2370/119; B60K 2370/148; B60K 2370/589; H04W 4/44

(57) ABSTRACT

The present disclosure relates to an electronic device and system for in-vehicle payment. According to an embodiment, an electronic device installed inside a vehicle can operate in a vehicle entry state when entry of the vehicle into a specific area is confirmed, request payment information from a server through a communication circuit when a payment initiation condition is confirmed while operating in the vehicle entry state, receive the payment information through the communication circuit, provide, through a display, an interface for payment based on the received payment information, and request a payment from the server through the communication circuit when a payment confirmation input is detected on the displayed interface. Other embodiments can be applied.

### CROSS-REFERENCE TO RELATED APPLICATIONS

This application is the U.S. National Stage filing under 35 U.S.C. § 371 of International Patent Application No. PCT/KR2019/013964, filed on Oct. 23, 2019, which in turn claims priority under PCT Article 8 and/or 35 U.S.C. § 119(a) to Korean Patent Application No. KR 10-2018-0144889, filed on Nov. 21, 2018, which is incorporated herein by reference in its entirety.

### TECHNICAL FIELD

The present disclosure relates to an electronic device and system for in-vehicle payment. More specifically, in the present disclosure, an electronic device and system capable of combining a plurality of payments for service use in a specific area inside a vehicle are described.

### BACKGROUND

Unless otherwise indicated herein, the materials described in this section are not prior art to the claims in this application and are not admitted as prior art by inclusion in this section.

Due to advances in electronic control technology, various vehicular devices, which have been conventionally operated through mechanical methods, are now operated by electrical methods for the enhancement of driver convenience and safety. Also, vehicle systems are gradually becoming more advanced. Further, recently, a vehicle has been equipped with a telematics device to provide a smart control service that enables remote air conditioning, unlocking and locking of vehicle doors, parking location check, destination transmission, and vehicle status check with a smartphone, safety and security services such as emergency dispatch service, anti-theft tracking service, and burglar alarm service, a driving service that guides the fastest route by using real-time traffic information, and a vehicle management service that conducts a vehicle condition diagnosis and informs whether the vehicle needs to be repaired.

However, conventional telematics services are mainly involved in the above-described smart control service, safety and security services, driving service, and vehicle management service with a focus on voice recognition and communication. Recently, an electric vehicle service, pay-as-you-drive (PAYD) insurance in which premiums are based on how a driver drives a vehicle, a fleet management service, and an electronic tolling service have been further provided.

### SUMMARY

In view of the foregoing, the present disclosure provides a vehicle user with an in-vehicle payment service using a telematics device in addition to the above-described services. For example, the vehicle user may encounter various situations requiring payment while driving the vehicle. When the vehicle enters a specific area that provides various services, the user may need to make payments for respective uses of various services provided in the specific area. For example, when the user drives the vehicle and enters a specific area such as a complex shopping mall, the user may need to make a payment for a purchase at the shopping mall and a payment for a parking fee at the time of exit of the vehicle separately. Accordingly, the present disclosure provides an electronic device and system that enables payments in a specific area at a time inside a vehicle.

According to an embodiment of the present disclosure, an electronic device installed inside a vehicle includes: at least one communication circuit; a display; at least one processor operatively connected to the display and the communication circuit; and at least one memory electrically connected to the processor. The memory is configured to store an application program including a user interface, and the memory stores instructions configured, when executed, to causes the processor to operate in a vehicle entry state when entry of the vehicle into a specific area is confirmed, to request payment information from a server through the communication circuit when a payment initiation condition is confirmed while operating in the vehicle entry state, to receive the payment information through the communication circuit, to provide, through the display, an interface for payment based on the received payment information, and to request a payment from the server through the communication circuit when a payment confirmation input is detected on the displayed interface.

In the electronic device according to an embodiment, the entry into the specific area may be confirmed when an entry approval signal is received from the server through a long-range wireless communication network based on a passage of the vehicle through a vehicle access control system installed in the specific area.

In the electronic device according to an embodiment, the entry into the specific area may be confirmed when an entry approval signal is received from a vehicle access control system installed in the specific area through a short-range wireless communication network based on a passage of the vehicle through the vehicle access control system.

In the embodiment, the payment initiation condition may include at least one of when an engine start of the vehicle is detected, when the vehicle is driven for a predetermined period or more after the engine start, and when a payment request input from a user is detected.

In the embodiment, the payment request input may be any one of an input to a mechanical button installed at the vehicle, an input to an icon displayed on the display, a voice input received through a microphone installed at the vehicle, or an input from a user device.

In the embodiment, the memory may further store an instruction configured, when executed, to cause the processor to disable the operation in the vehicle entry state after the processor requests the payment from the server.

In the embodiment, the memory may further store an instruction configured, when executed, to cause the processor to receive a vehicle information request signal through the communication circuit while operating in the vehicle entry state, and to transmit vehicle information through the communication circuit in response to the received vehicle information request signal.

According to an embodiment of the present disclosure, a system for in-vehicle payment service in a specific area includes: an electronic device that is configured to operate in a vehicle entry state when entry of a vehicle into a specific area is confirmed and to request payment information from a server when a payment initiation condition is confirmed while operating in the vehicle entry state; and a server that is configured to generate payment information in response to the request for the payment information of the vehicle and to provide the payment information to the electronic device. The electronic device may be further configured to provide an interface for payment based on the payment information provided from the server and to request a payment from the server when a payment input from a user is detected on the provided interface for payment. The server may be further configured to perform a payment process in response to the request for the payment.

In the embodiment, the system may further include a vehicle access control system that is configured to acquire a vehicle plate number image of the vehicle and to transmit the vehicle plate number image to the server for a vehicle plate number recognition process.

In the embodiment, in the system, the server may be configured to perform the vehicle plate number recognition process based on the vehicle plate number image received from the vehicle access control system, to provide the recognized vehicle plate number to the vehicle access control system, and to transmit entry approval information to the electronic device corresponding to the recognized vehicle plate number.

In the embodiment, in the system, the electronic device may be configured to operate in the vehicle entry state when receiving the entry approval information from the server.

In the embodiment, in the system, the payment initiation condition may include at least one of when an engine start of the vehicle is detected, when the vehicle is driven for a predetermined period or more after the engine start, and when a payment request input from the user is detected.

In the embodiment, in the system, the payment request input may be any one of an input to a mechanical button installed at the vehicle, an input to an icon displayed on the display, a voice input received through a microphone installed at the vehicle, or an input from a user device.

In the embodiment, in the system, the electronic device may be configured to disable the operation in the vehicle entry state after requesting the payment from the server through a communication circuit.

In the embodiment, in the system, the server may be configured to transmit a notification of payment completion to each of the electronic device and the vehicle access control system after processing the payment.

In the embodiment, in the system, the electronic device may be configured to disable the operation in the vehicle entry state receiving the notification of payment completion from the server.

In the embodiment, in the system, the vehicle access control system may be configured to check a settlement of a fee and perform a vehicle exit process after receiving the notification of payment completion from the server.

### BRIEF DESCRIPTION OF THE DRAWINGS

The foregoing and other features of the present disclosure will be described in detail with reference to the accompanying drawings. Understanding that these drawings depict only several examples in accordance with the disclosure and are, therefore, not to be considered limiting of its scope, the disclosure will be described with additional specificity and detail through the use of the accompanying drawings, in which:

FIG. 1 is a schematic diagram illustrating a system for in-vehicle payment, in accordance with an embodiment of the present disclosure;

FIG. 2 is a depiction of an exemplary configuration of an integrated management server;

FIG. 3 is a functional block diagram of an electronic device for implementing in-vehicle payment, in accordance with an embodiment of the present disclosure;

FIG. 4 is a flowchart showing an exemplary payment process performed by the electronic device installed inside a vehicle, in accordance with an embodiment of the present disclosure;

FIG. 5 through FIG. 7 illustrate operation examples of components of the electronic device installed inside the vehicle, in accordance with an embodiment of the present disclosure; and

FIG. 8 is a flowchart showing an exemplary in-vehicle payment process performed by a system including a vehicle access control system installed in a specific area, a vehicle that enters the specific area and a server, in accordance with an embodiment of the present disclosure.

### DETAILED DESCRIPTION

Hereafter, embodiments and examples will be described in detail with reference to the accompanying drawings so that the present disclosure may be readily implemented by those of ordinary skill in the art. However, it is to be noted that the present disclosure is not limited to the embodiments and examples but can be embodied in various other ways.

The present disclosure generally relates to an electronic device and system for in-vehicle payment. More specifically, in the present disclosure, an electronic device and system capable of combining a plurality of payments for service use in a specific area inside a vehicle are described.

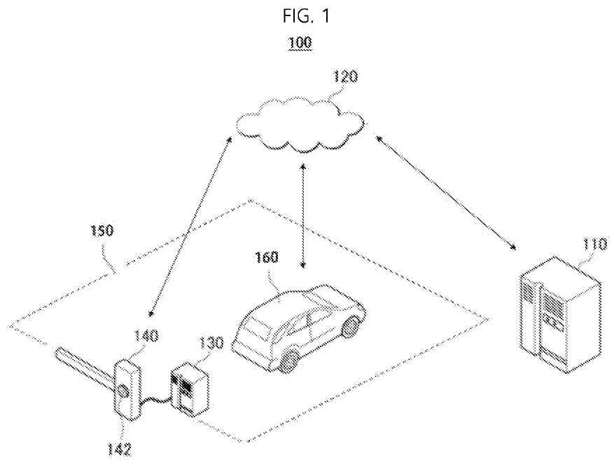

FIG. 1 is a schematic diagram illustrating a system 100 for in-vehicle payment, in accordance with an embodiment of the present disclosure. A central server 110 and/or a local server 130 may be any computing device having an application server, a standalone server, a web server, other data transmission/reception functions, data identification functions and data processing functions. A network 120 may be composed of any device having a computer network, the Internet, a telephone network, a TCP/IP data network (including WAN, LAN, VPN, etc.) and other communication functions.

A vehicle access control system 140 may be installed at the entrance of a parking lot 150 and configured to raise a barrier to allow a vehicle 160 to enter the parking lot if a vehicle plate number of vehicle 160 is recognized when vehicle 160 enters the parking lot 150. The vehicle plate number of vehicle 160 is recognized by an image acquisition device 142, for example, a camera, provided at a barrier gate or installed around the barrier gate. The image acquisition device 142 takes front and/or rear images of the vehicle and transmits the images to a local server 130, and local server 130 recognizes the vehicle plate number from the images by using OCR technology. Therefore, hereinafter, image acquisition device 142 may be referred to as a “license plate recognition (LPR) device”.

Herein, LPR device 142 can be any imaging device as long as it can acquire a front or rear image including a license plate of a vehicle and the acquired image has a sufficient resolution to recognize a vehicle plate number with an OCR program.

When local server 130 recognizes the vehicle plate number based on the images of vehicle 160 taken by LPR device 142, vehicle access control system 140 raises the barrier to allow entry of vehicle 160 and local server 130 processes entry of vehicle 160 into the parking lot 150 based on the vehicle plate number at the same time. However, the vehicle plate number may not be recognized from the images of vehicle 160, e.g., under-recognition or misrecognition of the vehicle plate number may occur. Such under-recognition or misrecognition of the vehicle plate number may be caused by various factors. For example, the images of the license plate may not be sufficiently clear to recognize the vehicle plate number with the OCR program, or there may be an error in the OCR program. Even when under-recognition or misrecognition of the vehicle plate number occurs, vehicle access control system 140 raises the barrier and allows entry of vehicle 160, but the entry process of vehicle 160 is deferred until the vehicle plate number is exactly confirmed. Processing and checking of the under-recognized or misrecognized vehicle plate number are not performed by local server 130 of the parking lot. The images of vehicle 160 including the under-recognized or misrecognized license plate may be transmitted to central server 110 through network 120 and then, processing and checking of the under-recognized or misrecognized vehicle plate number may be performed through central server 110. To this end, for example, cloud computing, distributed computing, or client-server computing technology may be used.

Central server 110 and local server 130 may be used for settlement of a parking fee and other services. For example, local server 130 may generate payment information by collecting fees to be charged, and central server 110 may be configured to be associated with a payment system to enable the charged fees to be paid and settled. The payment information may include parking fee information based on parking time, discount information, and other payment information. The other payment information may include fee information about a car wash system installed in parking lot 150, fee information about an electric vehicle charging system installed in parking lot 150, and payment information in a specific place (for example, a repair shop, a shopping mall, etc.) to which parking lot 150 belongs, but is not limited to the examples described herein.

Vehicle 160 may be configured to communicate with an external device. For example, vehicle 160 may be configured to communicate with central server 110, local server 130, a base station (not shown), or an external electronic device (for example, a user device). A long-range wireless network and a short-range wireless network may be used for communication with the external device, and a wired network may also be used. Vehicle 160 may perform or receive various services, such as payment service and parking location check service, through communication with the external device.

Local server 130 may sum up a charging fee calculated based on, for example, vehicle model, charging time, supply capacity, type of charger and/or charging speed and a parking fee calculated based on vehicle model, date and time of entry, date and time of parking on a charging parking surface, date and time of completion of charging and/or date and time of preliminary settlement request, set the sum of the fees as a fee to be paid at the time of settlement, and provide such information to central server 110.

Central server 110 may perform a fee settlement for an outgoing vehicle based on the vehicle plate number and a fee of the outgoing vehicle. Central server 110 may generate payment information in response to a request for payment information. The payment information may be generated based on spending details of a user corresponding to the vehicle plate number, discount details of the user corresponding to the vehicle plate number, and a parking fee based on the parking time of the vehicle corresponding to the vehicle plate number.

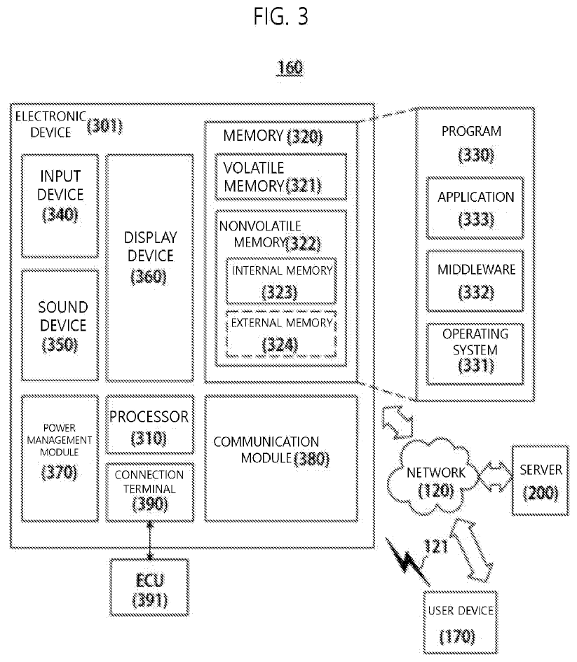

According to an embodiment, central server 110 may be configured to provide the generated payment information to vehicle 160 in order to provide an in-vehicle payment service. Also, central server 110 may perform an automatic payment of the fee based on automatic payment information registered in advance corresponding to the fee and the vehicle plate number of the outgoing vehicle. When the preliminary settlement or automatic payment is confirmed, central server 110 may transmit a notification of payment completion to vehicle access control system 140 and/or local server 130. For example, vehicle access control system 140 and/or local server 130 may check whether or not a fee settlement for the outgoing vehicle has been completed based on the notification of payment completion from central server 110. Vehicle access control system 140 and/or local server 130 may enable a vehicle for which a preliminary settlement or automatic payment has not been performed to perform a payment of the fee at vehicle access control system 140 to perform a settlement of the fee. According to another embodiment, central server 110 may check whether or not the fee has been preliminarily settled through the user device (for example, 170 in FIG. 3).

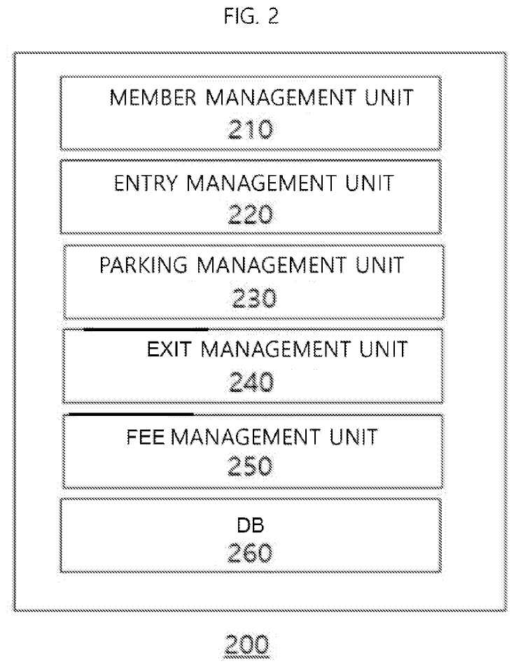

FIG. 2 is a depiction of an exemplary configuration of an integrated management server.

FIG. 2 is a depiction of an exemplary configuration of an integrated management server 200 when central server 110 and local server 130 connected to each other in a communicative manner through network 120 as illustrated in FIG. 1 are viewed as single integrated management server 200. Integrated management server 200 may include a member management unit 210 for performing a process associated with vehicle 160, an entry management unit 220 for performing a process associated with vehicle 160 and parking lot 150, a parking management unit 230, an exit management unit 240 and/or fee management unit 250, a database (DB) 260 for storing and managing all data necessary for performing the processes, and the like. Here, entry management unit 220 may perform all processes in relation to entry of vehicle 160 and the LPR device 142. Exit management unit 240 may be operatively connected to LPR device 142 and may perform all processes in relation to LPR device 142. Fee management unit 250 may perform all processes in relation to the calculation and settlement of a fee.

Member management unit 210 may manage information about the user corresponding to the confirmed vehicle plate number. Member management unit 210 may collect and manage spending information of the user corresponding to the confirmed vehicle plate number after the user drives the vehicle and enters a specific area.

Entry management unit 220 may determine whether or not vehicle 160 enters the parking lot 150. For example, when vehicle 160 enters the entranceway to enter parking lot 150, entry management unit 220 may provide user device 170 correspondings to vehicle 160 with information about a specific area where vehicle 160 enters based on a plate number of the incoming vehicle recognized by vehicle access control system 140.

Exit management unit 240 may determine whether or not vehicle 160 exits from parking lot 150. For example, when vehicle 160 enters the exitway to exit from parking lot 150, exit management unit 240 may check outgoing vehicle information based on a plate number of the outgoing vehicle recognized by vehicle access control system 140.

Fee management unit 250 may settle the fee of vehicle 160 based on the outgoing vehicle information. As another example, when in-vehicle payment is requested, fee management unit 250 may settle the fee of vehicle 160 based on time of request. For example, fee management unit 250 may check whether or not a preliminary settlement (for example, in-vehicle payment) for the vehicle has been performed at a charger 156. When the charging fee and/or the parking fee of vehicle 160 needs to be paid, if there is automatic payment information registered in advance by member management unit 210, fee management unit 250 may settle the fee through automatic payment. When the settlement has been completed, exit management unit 240 may approve the exit of vehicle 160.

FIG. 3 is a functional block diagram of an electronic device for implementing in-vehicle payment, in accordance with an embodiment of the present disclosure. Referring to FIG. 3, an electronic device 301 installed inside vehicle 160 may communicate with user device 170 or server 200 through network 120 (for example, a long-range wireless communication network) or communicate with user device 170 through a short-range wireless communication network 121. According to an embodiment, electronic device 301 may communicate with an electronic device 104 through server 200.

According to an embodiment, electronic device 301 may include a processor 310, a memory 320, an input device 340, a sound device 350, a display device (or display) 360, a power management module 370, or a communication module 380. In some embodiments, at least one of the components (for example, a display device 360 or a camera module) may be omitted or one or more other components may be added to electronic device 301. In some embodiments, some of the components may be implemented with a single integrated circuit. For example, an input device 340 (for example, a touch circuitry) may be implemented to be embedded in display device 360.

Processor 310 may control at least one other component (for example, a hardware or software component) of electronic device 301 connected to processor 310 by executing, for example, software (for example, a program 330) and may perform various data processing or calculations. According to an embodiment, as at least a part of the data processing or calculations, processor 310 may load an instruction or data received from another component (for example, input device 340 or a communication module 380) to a volatile memory 321, process the instruction or data stored in volatile memory 321, and store the resultant data in a nonvolatile memory 322. According to an embodiment, processor 310 may include a main processor (for example, a central processing unit or an application processor) and an auxiliary processor (for example, a graphic processing unit, an image signal processor, a sensor hub processor, or a communication processor) which may operate independently from the main processor or together with the main processor. Additionally or alternatively, the auxiliary processor may use lower power than the main processor or may be configured to specialize in a predetermined function. The auxiliary processor may be implemented separately from or as a part of the main processor.

Memory 320 may store various data used by at least one component (for example, processor 310) of electronic device 301. The data may include, for example, software (for example, a program 330) and input data or output data on an instruction related thereto. Memory 320 may include volatile memory 321 or nonvolatile memory 322.

Program 330 may be stored in memory 320 and may include, for example, an operating system 331, middleware 332, or an application 333.

Input device 340 may receive an instruction or data to be used by the component (for example, processor 310) of electronic device 301 from the outside (for example, the user) of electronic device 301. Input device 340 may include, for example, a touch panel and a button type or dial type physical input means.

Sound device 350 may output a sound signal to the outside of electronic device 301 or receive a sound signal. Sound device 350 may include, for example, a speaker or a recorder. The speaker may be used for general purposes, such as reproducing multimedia or recording, and the recorder may be used for receiving a voice instruction of the user. According to an embodiment, the recorder may be implemented separately from the speaker or as a part of the speaker.

Display device 360 may visually provide information to the outside (for example, the user) of electronic device 301. Display device 360 may include, for example, a display, a hologram device, a projector, and a control circuit for controlling the corresponding device. According to an embodiment, display device 360 may include a touch circuitry configured to detect a touch, or a sensor circuit (for example, a pressure sensor) configured to measure the intensity of force generated by the touch.

Power management module 370 may manage power supplied to electronic device 301. According to an embodiment, power management module 370 may be implemented as at least a part of, for example, a power management integrated circuit (PMIC). According to an embodiment, electronic device 301 may manage power supplied from the outside (for example, vehicle 160) and/or power of an internal battery through power management module 370. For example, power management module 370 may charge the internal battery with power supplied from vehicle 160, and may supply power to electronic device 301 and charge the internal battery at the same time.

Communication module 380 may support establishment of a direct (for example, wired) communication channel or a wireless communication channel between electronic device 301 and the external electronic device (for example, user device 170 or server 200) and communication through the established communication channel. Communication module 380 may include one or more communication processors that operate independently from processor 310 (for example, the application processor) and support direct (for example, wired) communication or wireless communication. According to an embodiment, the communication module may include a wireless communication module (for example, a cellular communication module, a short-range wireless communication module, or a global navigation satellite system (GNSS) communication module) or a wired communication module (for example, a local area network (LAN) communication module or a power line communication module). Among these communication modules, the corresponding communication module may communicate with the external electronic device through network 120 (for example, a long-range communication network such as a cellular network, Internet, or a computer network (for example, LAN or WAN))) or a short-range network 121 (for example, a short-range communication network such as Bluetooth, Wi-Fi direct or infrared data association (IrDA)). Such various types of communication modules may be integrated into one component (for example, a single chip) or may be implemented with a plurality of separate components (for example, a plurality of chips).

A connection terminal 390 may include a connector which physically connects electronic device 301 to an ECU 391. ECU 391 may be configured to control all vehicle operations, such as driving, braking and steering, of vehicle 160. For example, ECU 391 may be configured to control an engine, an automatic transmission, an anti-lock brake system (ABS), and the like. In another embodiment, ECU 391 may be included in electronic device 301. In yet another embodiment, ECU 391 may function as processor 310 of electronic device 301 or function as a substitute for processor 310.

At least some of the components may be connected to each other through a communication scheme between peripheral devices (for example, a bus, general purpose input and output (GPIO), a serial peripheral interface (SPI), or a mobile industry processor interface (MIPI)) and exchange signals (for example, instruction or data) therebetween.

According to an embodiment, an instruction or data may be transmitted or received between electronic device 301 and an external electronic device 170 through server 200 connected to network 120. User device 170 may be electronic device 301 and various types of electronic devices. User device 170 may include, for example, a portable communication device (for example, a smart phone), a computer device, a portable multimedia device, a portable medical device, a camera, a wearable device, or a home appliance. User device 170 is not limited to the above-described devices.

The term “module” as used herein may include a unit implemented with hardware, software, or firmware, and may be used interchangeably with the term, for example, “logic,” “logical block,” “component,” “circuit,” or the like. The module may be an integrated component, or a minimum unit for performing one or more functions or a part thereof. For example, according to an embodiment, a module may be implemented in the form of an application-specific integrated circuit (ASIC).

Various embodiments disclosed herein may be implemented by software (for example, program 330) including one or more instructions stored in a machine (for example, electronic device 301)-readable storage medium (for example, an internal memory 323 or an external memory 324). The machine (for example, a processor (for example, processor 310) of electronic device 301) may retrieve at least one of the one or more instructions from the storage medium and execute the retrieved at least one instruction. This enables the device to operate to perform at least one function according to the retrieved at least one instruction. The one or more instructions may include a code that is generated by a compiler or executed by an interpreter. The machine-readable storage medium may be provided in the form of a non-transitory storage medium. Here, the term “non-transitory” only means that the storage medium is tangible without including a signal, irrespective of whether data are semi-permanently or transitorily stored in the storage medium.

The method according to various embodiments disclosed herein may be included and provided in a computer program product. The computer program product may be traded as a product between a seller and a buyer. The computer program product may be distributed in the form of a machine-readable storage medium (for example, compact disc read only memory (CD-ROM)), or may be distributed online via an application store (for example, Play Store™) or between two user devices (for example, a navigation device and a smartphone). If distributed online, at least a part of the computer program product may be temporarily generated or temporarily stored in the machine-readable storage medium, such as memory of the manufacturer's server, a server of the application store, or a relay server.

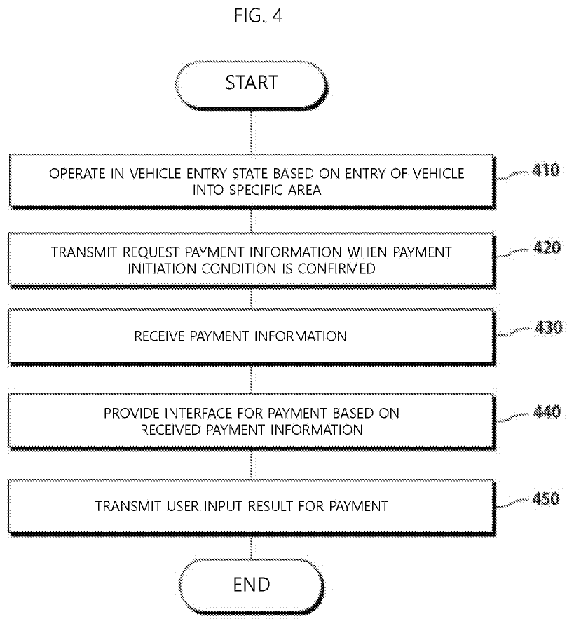

FIG. 4 is a flowchart showing an exemplary payment process performed by the electronic device installed inside a vehicle, in accordance with an embodiment of the present disclosure. The flowchart of FIG. 4 relates to an algorithm implemented on electronic device 301 installed inside vehicle 160. Hereinafter, each component of electronic device 301 of FIG. 3 is used to explain each process of FIG. 4, but the processes are not necessarily limited to the components shown in FIG. 3.

A process may begin at block 410 where electronic device 301 operates in a vehicle entry state based on entry of vehicle 160 into a specific area (for example, parking lot 150 in FIG. 1). Vehicle 160 may enter the specific area by passing through a vehicle access control system (for example, 140 in FIG. 1). Electronic device 301 installed inside vehicle 160 may operate in the vehicle entry state when receiving a signal confirming entry into the specific area from the outside. For example, electronic device may receive an entry approval signal from vehicle access control system 140 through a wireless communication network (for example, short-range wireless communication network 121). As another example, electronic device 301 may receive an entry approval signal from server 200 (for example, local server 130 and/or central server 110) operatively connected to vehicle access control system 140 through a wireless communication network (for example, long-range wireless communication network 120). As yet another example, electronic device 301 may attempt to receive an entry approval signal from server 200 through a long-range wireless communication network and if it is determined that the long-range wireless communication network is not available, electronic device 301 may receive an entry approval signal from vehicle access control system 140 through a short-range wireless communication network.

Herein, the term “vehicle entry state” may refer to a state in which vehicle 160 enters a specific area that provides a service such as in-vehicle payment. When vehicle 160 operates in the vehicle entry state, electronic device 301 installed inside vehicle 160 may control at least some related components (for example, communication module 380) for providing a service that can be provided within the specific area until the vehicle entry state is released. For example, processor 310 of electronic device 301 may be activated to control at least some of the components even when vehicle 160 is turned off. As another example, electronic device 301 may further include a coprocessor capable of controlling at least some of the components of electronic device 301 while the processor is in an inactive (for example, sleep) state in the vehicle entry state. When electronic device 301 installed inside vehicle 160 operating in the vehicle entry state confirms a payment initiation condition, block 420 to transmit a payment information request signal is initiated.

At block 420, electronic device 301 operating in the vehicle entry state may check a payment initiation condition. Herein, the term “payment initiation condition” refers to various conditions indicating a willingness to make an in-vehicle payment for a service fee incurred while vehicle 160 stays in the specific area.

According to an embodiment, after the engine is turned off, electronic device 301 may check a payment initiation condition when an engine start of the vehicle is detected. This is a case where the user of vehicle 160 stops the engine for parking, uses a service in the specific area, and then restarts the engine to exit, which can be regarded as a payment initiation condition. Electronic device 301 may receive information about vehicle driving from ECU 391 of vehicle 160 to detect a stop and a start of the engine. Electronic device 301 may check the payment initiation condition when an engine start is detected after a predetermined period from the stop of the engine. The predetermined period may be, for example, the minimum time for charging a parking fee. According to another embodiment, electronic device 301 may check the payment initiation condition when the predetermined period elapses after an engine start is detected. This is because the reason for the restart may not be a true exit, but may be a change of parking posture or location of vehicle 160.

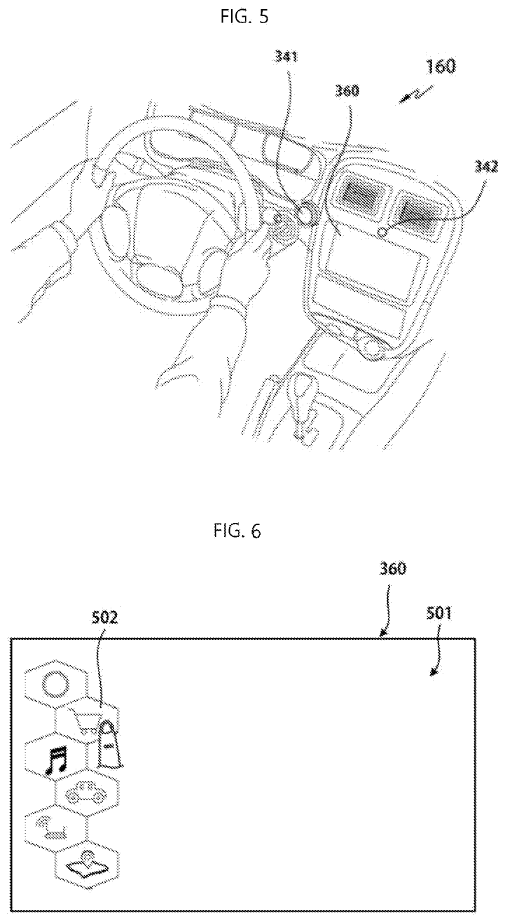

In some embodiments, electronic device 301 may check the payment initiation condition through a user input to input device 340 installed in vehicle 160. This will be described in detail with reference to FIG. 5 through FIG. 7. For example, vehicle 160 may include a separate physical key (for example, a button 341 in FIG. 5) for in-vehicle payment. Physical key 341 may include a push button or a dial key. Electronic device 301 may check the payment initiation condition when detecting a user input to physical key 341.

In another embodiment, electronic device 301 may check the payment initiation condition in response to a user input on an interface displayed on display device 360. Referring to FIG. 5, vehicle 160 may include display device 360 capable of interacting with the user. Referring to FIG. 6, electronic device 301 may display an interface 501 for payment and an icon 502 corresponding to the payment initiation condition through display device 360. Electronic device 301 may check the payment initiation condition when receiving a user input (for example, a touch input) to icon 502.

In yet another embodiment, vehicle 160 may check the payment initiation condition through the user's voice input through a microphone (for example, 342 in FIG. 5). For example, when electronic device 301 may check the payment initiation condition when detecting receipt of predetermined specific voice input (for example, the user's voice saying “in-vehicle payment”).

When the payment initiation condition is confirmed, electronic device 301 may transmit a payment information request signal through communication module 380. The payment information request signal may be transmitted to server 200 (for example, local server 130 or central server 110) through long-range wireless network 120.

Then, the process may continue to block 430 where electronic device 301 can receive payment information. The payment information may be transmitted from server 200 in response to the payment information request signal transmitted by electronic device 301. In another embodiment, the payment information may be transmitted from server 200 at regular intervals without a special request from electronic device 301. The payment information indicates information about the amount to be paid by the user corresponding to vehicle 160 (or vehicle plate number). The user may use various services, such as a parking service, a car wash service, shopping, and the like, in the specific area. That is, the payment information may include a parking fee in a specific area (for example, parking lot 150), spending for purchase in a specific area (for example, items purchased in a shopping mall or market), a car wash fee or electric vehicle charging fee. The payment information may further include payment exemption information depending on the presence or absence of a discount coupon or a discount event, or the use of accumulated points.

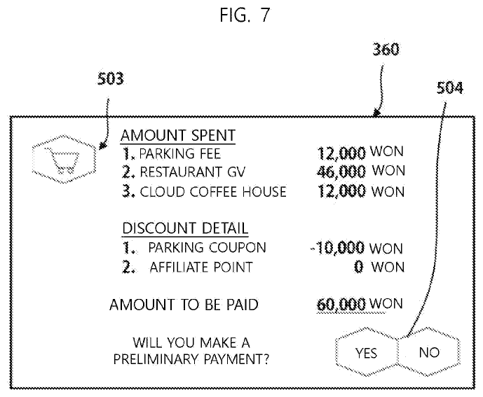

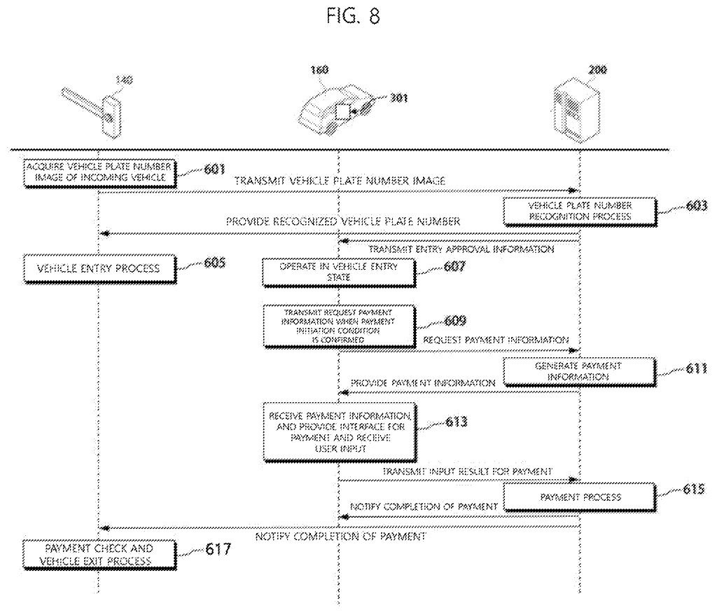

The process may continue to block 440 where electronic device 301 can provide an interface for payment based on the received payment information. According to an embodiment, electronic device 301 may display an interface for payment (503 in FIG. 7) on display device 360. Interface 503 may display an amount spent, a discount amount, and an amount paid. Interface 503 may further include an icon 504 to receive an input on whether to make an in-vehicle payment.

In another embodiment, electronic device 301 may provide an interface for payment as a voice signal through a sound device (for example, 350 in FIG. 3). Electronic device 301 may receive whether or not to make an in-vehicle payment in the form of a voice signal, an input to a physical button, or the like. However, the embodiment is not limited thereto, and a payment may be performed without displaying an interface for asking the user whether or not to make a payment depending on a predetermined setting. Electronic device 301 may further provide an interface for confirming whether or not the payment information, for example, final payment information is correct.

The process may continue to block 450 where electronic device 301 can transmit a user input result for payment to server 200. Server 200 may perform a payment based on information about the user corresponding to vehicle 160 (or electronic device 301) based on the user input result transmitted from electronic device 301. Electronic device 301 may disable the operation in the vehicle entry state after transmitting the user input result for payment. In another embodiment, electronic device 301 may directly transmit the user input result for payment to vehicle access control system 140. The process may be ended after electronic device 301 transmits the user input result for payment to server 200.

FIG. 8 is a flowchart showing an exemplary in-vehicle payment process performed by a system including a vehicle access control system installed in a specific area, a vehicle that enters the specific area and a server, in accordance with an embodiment of the present disclosure. The flowchart of FIG. 8 is based on an algorithm implemented on vehicle access control system 140, vehicle 160 and server 200 shown in FIG. 1 through FIG. 3, and a detailed description of the process already described above may be omitted.

A process may begin at block 601 where vehicle plate number images of incoming vehicle 160 are acquired when vehicle 160 passes through vehicle access control system 140 to enter a specific area (for example, parking lot 150 in FIG. 1). Vehicle access control system 140 may acquire an image of incoming vehicle 160. The images of the vehicle may include front and/or rear images of vehicle 160 and may include a license plate of the vehicle. Vehicle access control system 140 may recognize a vehicle plate number of vehicle 160 based on the acquired vehicle plate number images. When under-recognition of the vehicle plate number of vehicle 160 occurs, vehicle access control system 140 may transmit the acquired vehicle plate number images to server 200 in order to check the vehicle plate number. The vehicle plate number images may be transmitted to server 200 directly or via another server.

Then, at block 603, server 200 may recognize the vehicle plate number by using the received vehicle plate number images. Server 200 may check the vehicle plate number based on the received vehicle plate number images by using big data technology, cloud computing technology, distributed computing technology, client-server computing technology, or machine-learning technology. Server 200 may provide the checked vehicle plate number to vehicle access control system 140. Also, server 200 may transmit entry approval information to vehicle 160 of the user corresponding to the checked vehicle plate number.

According to another embodiment, vehicle access control system 140 may accurately recognize the vehicle plate number of vehicle 160 based on the acquired vehicle plate number images. In this case, vehicle access control system 140 may provide only the recognized vehicle plate number information to server 200 without a need to request the vehicle plate number from server 200. Server 200 may transmit entry approval information to vehicle 160 of the user corresponding to the vehicle information provided from vehicle access control system 140. In another embodiment, vehicle access control system 140 may provide an entry approval signal directly to vehicle 160 (or electronic device 301) through a short-range wireless communication network.

Then, at block 605, vehicle access control system 140 may process entry of vehicle 160. For example, in the vehicle entry process, vehicle access control system 140 may raise a barrier to allow entry of vehicle 160 and check the time of entry of vehicle 160. The time of entry may be used for calculating a parking fee.

At block 607, electronic device 301 (or vehicle 160) may operate in a vehicle entry state based on entry of vehicle 160 into a specific area. For example, electronic device 301 may operate in the vehicle entry state in response to the entry approval signal (or a signal confirming the entry of vehicle 160) transmitted from server 200. The operation of electronic device 301 at block 607 may be similar to the operation at block 410 of FIG. 4 or may include at least a part of the operation at block 410 of FIG. 4.

Then, at block 609, electronic device 301 (or vehicle 160) may request payment information when a payment initiation condition is confirmed. The payment initiation condition may include at least one of when an engine start of vehicle 160 is detected, when a predetermined period elapses after the engine start, and when the user inputs to initiate a payment. Electronic device 301 may transmit a payment information request signal to server 200. The operation of electronic device 301 at block 609 may be similar to the operation at block 420 of FIG. 4 or may include at least a part of the operation at block 420 of FIG. 4.

Then, at block 611, server 200 may generate payment information in response to the payment information request signal received from electronic device 301. For example, server 200 may generate payment information by collecting fees to be charged, and the payment information may include parking fee information based on parking time, discount information, and other payment information. The other payment information may include fee information about a car wash system installed in parking lot 150, fee information about an electric vehicle charging system installed in parking lot 150, and payment information in a specific place (for example, a repair shop, a shopping mall, etc.) to which parking lot 150 belongs. As another example, the payment information may be generated based on, but not limited to, spending details of a user corresponding to the vehicle plate number, discount details, such as affiliate discount, membership discount or card point discount, of the user corresponding to the vehicle plate number, a parking fee based on parking time of the vehicle corresponding to the vehicle plate number.

Then, at block 613, electronic device 301 may receive the payment information and provide an interface for payment (for example, 503 in FIG. 6) based on the received payment information. Electronic device 301 may check the amount to be paid and whether or not to make an in-vehicle payment by interactions with the user through the provided interface. Electronic device 301 may transmit an input result for payment, as determined by the user, to server 200.

Then, at block 615, server 200 may perform a payment process in response to the input result for payment received from electronic device 301. When the received input result for payment indicates an instruction to make an in-vehicle payment, server 200 may perform an automatic payment for the fee to be paid based on automatic payment information registered in advance in relation to the user corresponding to the payment information and the vehicle plate number of the outgoing vehicle. Server 200 may transmit a notification of payment completion to vehicle access control system 140 and/or local server 130 when confirming the completion of automatic payment.

At block 617, vehicle access control system 140 may check a settlement of the fee and perform a vehicle exit process based on whether or not to make an in-vehicle payment received from server 200. Vehicle access control system 140 may check whether or not a fee settlement for the outgoing vehicle has been completed based on, for example, a notification of settlement completion from server 200. Vehicle access control system 140 may enable a vehicle for which a preliminary settlement or automatic payment has not been performed to perform a payment of the fee at vehicle access control system 140 to perform a settlement of the fee. For example, if vehicle access control system 140 does not receive a signal indicating the completion of payment or a signal indicating non-completion of payment from server 200, vehicle access control system 140 may perform a payment process.

According to another embodiment, vehicle access control system 140 may also check whether or not a preliminary settlement for the fee has been performed through a user device (for example, 170 in FIG. 3). Vehicle access control system 140 may transmit a request signal to server 200 to check whether or not the preliminary settlement has been performed.

As described above, the user can make an automatic payment using an in-vehicle payment service according to the present disclosure without performing a separate payment process. Also, the user can combine a plurality of payment processes in a specific area into a single payment and park a vehicle in the specific area (including vehicle entry and vehicle exit) with convenience without an additional process such as getting or registering a parking ticket.

The above description of the present disclosure is provided for the purpose of illustration, and it would be understood by a person with ordinary skill in the art that various changes and modifications may be made without changing technical conception and essential features of the present disclosure. For example, the specific area has been described above as a parking lot of a complex shopping mall, but the specific area may be a complex space, such as a concert hall, a drive-in theater, a festival site, which allows a vehicle to enter and provides various payment services. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

There is little distinction left between hardware and software implementations of aspects of systems; the use of hardware or software is generally a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

In the implementation of software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the present invention as defined by the appended claims and/or disclosed herein.

The programs (software modules or software) may be stored in nonvolatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of the may form a memory in which the program is stored. Further, a plurality of such memories may be included in the electronic device.

Further, the programs may be stored in an attachable storage device that is accessible through a communication network, such as the Internet, the Intranet, a local area network (LAN), wide LAN (WLAN), or storage area network (SAN), or a communication network configured with a combination thereof. The storage devices may be connected to an electronic device through an external port. Furthermore, a separate storage device on the communication network may access a device that performs an embodiment of the present disclosure.

In the above-described detailed embodiments of the present disclosure, the number of elements included in the present disclosure is expressed in the singular or the plural according to a presented detailed embodiment. However, the singular form or plural form is selected for convenience of description suitable for the presented situation, and various embodiments of the present disclosure are not limited to a single element or multiple elements thereof. Further, multiple elements expressed in the description may be configured into a single element or a single element in the description may be configured into multiple elements.

Although the embodiment has been described in the detailed description of the present disclosure, the present disclosure may be modified in various forms without departing from the scope of the present disclosure. Therefore, the scope of the present disclosure should not be defined as being limited to the embodiments, but should be defined by the appended claims and equivalents thereof.

While certain example techniques have been described and shown herein using various methods and systems, it should be understood by those of ordinary skill in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

Throughout this document, the term “connected to” may be used to designate a connection or coupling of one element to another element and includes both an element being “directly connected to” another element and an element being “electronically connected to” another element via another element. Throughout the whole document, the term “on” that is used to designate a position of one element with respect to another element includes both a case that the one element is adjacent to the other element and a case that any other element exists between these two elements. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. An electronic device installed inside a vehicle, the electronic device comprising:
at least one communication circuit;
a display;
at least one processor operatively connected to the display and the communication circuit; and
at least one memory electrically connected to the processor,
wherein the memory is configured to store an application program including a user interface, and
wherein the memory stores instructions configured, when executed,
to cause the processor to operate in a vehicle entry state when entry of the vehicle into a specific area is confirmed,
to request payment information from a server through the communication circuit when a payment initiation condition is confirmed while operating in the vehicle entry state,
to receive the payment information through the communication circuit,
to provide, through the display, an interface for payment based on the received payment information, and
to request a payment from the server through the communication circuit when a payment confirmation input is detected on the displayed interface.

2. The electronic device of claim 1, wherein the entry into the specific area is confirmed when an entry approval signal is received from the server through a long-range wireless communication network based on a passage of the vehicle through a vehicle access control system installed in the specific area.

3. The electronic device of claim 1, wherein the entry into the specific area is confirmed when an entry approval signal is received from a vehicle access control system installed in the specific area through a short-range wireless communication network based on a passage of the vehicle through the vehicle access control system.

4. The electronic device of claim 1, wherein the payment initiation condition includes at least one of when an engine start of the vehicle is detected, when the vehicle is driven for a predetermined period or more after the engine start, and when a payment request input from a user is detected.

5. The electronic device of claim 2, wherein the payment request input is any one of an input to a mechanical button installed at the vehicle, an input to an icon displayed on the display, a voice input received through a microphone installed at the vehicle, or an input from a user device.

6. The electronic device of claim 5, wherein the memory further stores an instruction configured, when executed, to cause the processor to disable the operation in the vehicle entry state after the processor requests the payment from the server.

7. The electronic device of claim 1, wherein the memory further stores an instruction configured, when executed,
to cause the processor to receive a vehicle information request signal through the communication circuit while operating in the vehicle entry state, and
to transmit vehicle information through the communication circuit in response to the received vehicle information request signal.

8. A system for in-vehicle payment service in a specific area, the system comprising:
an electronic device that is configured to operate in a vehicle entry state when entry of a vehicle into a specific area is confirmed and to request payment information from a server when a payment initiation condition is confirmed while operating in the vehicle entry state; and
a server that is configured to generate payment information in response to the request for the payment information of the vehicle and to provide the payment information to the electronic device,
wherein the electronic device is further configured to provide an interface for payment based on the payment information provided from the server and to request a payment from the server when a payment input from a user is detected on the provided interface for payment, and
wherein the server is further configured to perform a payment process in response to the request for the payment.

9. The system of claim 8, further comprising:
a vehicle access control system that is configured to acquire a vehicle plate number image of the vehicle and to transmit the vehicle plate number image to the server for a vehicle plate number recognition process.

10. The system of claim 9, wherein the server is configured to perform the vehicle plate number recognition process based on the vehicle plate number image received from the vehicle access control system, to provide the recognized vehicle plate number to the vehicle access control system, and to transmit entry approval information to the electronic device corresponding to the recognized vehicle plate number.

11. The system of claim 10, wherein the electronic device is configured to operate in the vehicle entry state when receiving the entry approval information from the server.

12. The system of claim 11, wherein the payment initiation condition includes at least one of when an engine start of the vehicle is detected, when the vehicle is driven for a predetermined period of time or more after the engine start, and when a payment request input from the user is detected.

13. The system of claim 8, wherein the payment request input is any one of an input to a mechanical button installed at the vehicle, an input to an icon displayed on the display, a voice input received through a microphone installed at the vehicle, or an input from a user device.

14. The system of claim 12, wherein the electronic device is configured to disable the operation in the vehicle entry state after requesting the payment from the server through a communication circuit.

15. The system of claim 8, wherein the server is configured to transmit a notification of payment completion to each of the electronic device and the vehicle access control system after processing the payment.

16. The system of claim 15, wherein the electronic device is configured to disable the operation in the vehicle entry state after receiving the notification of payment completion from the server.

17. The system of claim 15, wherein the vehicle access control system is configured to check a settlement of a fee and perform a vehicle exit process after receiving the notification of payment completion from the server.
